(19) United States
(12) Patent Application Publication
(10) Pub. No.: US 2019/0018478 A1
(43) Pub. Date: Jan. 17, 2019

(54) SENSING VIEWER DIRECTION OF VIEWING TO INVOKE ACCESSIBILITY MENU IN AUDIO VIDEO DEVICE

(71) Applicant: Sony Corporation, Tokyo (JP)

(72) Inventors: Peter Shintani, San Diego, CA (US); Brant Candelore, Escondido, CA (US); Mahyar Nejat, San Diego, CA (US)

(21) Appl. No.: 15/646,661

(22) Filed: Jul. 11, 2017

(51) Int. Cl. G06F 3/01; G06F 3/0484

(52) U.S. Cl. CPC G06F 3/013; G06F 3/04847

(57) ABSTRACT

A camera senses a direction in which a viewer such as a person whose vision is impaired by macular degeneration is looking. If the gaze is not straight ahead toward an audio video device (AVD) on which the camera may be mounted, visual impairment may be deduced, and a visual and/or audible accessibility menu automatically invoked. The AVD, for example, can play an audible prompt on speakers asking if the viewer would like to turn on a screen reader. This is especially advantageous where sighted and un-sighted persons share a common space with an AVD.

### FIELD

The present application relates to technically inventive, non-routine solutions that are necessarily rooted in computer technology and that produce concrete technical improvements.

### BACKGROUND

Visual impairments include maladies that cause loss of peripheral vision, such as glaucoma or sometimes retinitis pigmentosa, and maladies that cause loss of vision in the center of view, such as macular degeneration. People suffering from such impairments can experience difficulty viewing a video screen such as a TV because they must move their heads to see the entire video frame.

With particular respect to macular degeneration, a person suffering from this malady loses his or her center vision, so that such sufferers must cock their heads to one side in order to see anything in front of them.

### SUMMARY

Present principles recognize the above problem and recognizing that vision-impaired people may not gaze at a video display in a straight-on fashion, use that recognition to facilitate access to accessibility features.

Accordingly, an article of manufacture includes at least one computer memory that is not a transitory signal and that in turn includes instructions executable by at least one processor to receive at least one image of a person viewing a display device. The instructions are executable to, based at least in part on the image, determine a direction of viewing of the person and/or eye focus of the person, and based at least in part on the direction of viewing and/or eye focus of the person, selectively present at least one accessibility feature on the display device. To these ends, a single eye may be detected tracking motion on the screen, or both eyes may be detected tracking motion on the screen.

In example embodiments, the instructions are executable to, at a first time, determine that the direction of viewing is directly at the display device, and responsive to determining that the direction of viewing is directly at the display device, not present the at least one accessibility feature on the display device. The instructions are further executable to, at a second time, determine that the direction of viewing is not directly at the display device, and responsive to determining that the direction of viewing is not directly at the display device, present the at least one accessibility feature on the display device.

In some implementations, the instructions may be executable to determine the direction of viewing of the person only after the at least one image indicates that the person has looked in the direction of viewing for at least a predetermined period.

In an example embodiment, the accessibility feature includes at least one user interface (UI) that may be audible, visual, or both. The UI may include a talk back feature including an audio representation of accessibility options presented on a visual display.

In another aspect, a method includes receiving at least one image of at least one viewer, and based at least in part on the at least one image, determining whether the at least one viewer is looking directly at an audio video display device (AVDD). The method includes, responsive to determining that the at least one viewer is looking directly at the AVDD, presenting or continuing to present video on the AVDD. The method also includes, responsive to determining that the at least one viewer is not looking directly at the AVDD, automatically presenting at least one accessibility feature related to the AVDD.

In another aspect, a system includes at least one audio video device (AVD) that in turn includes at least one video display and at least one audio speaker. At least one camera is on the AVD, and circuitry is configured for receiving from the at least one camera at least one image of at least one viewer. The circuitry is further configured for, based at least in part on the at least one image indicating that the at least one viewer is not looking directly at the video display, automatically presenting on the AVDD at least one accessibility feature.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIGS. 2A and 2B are schematic top plan views showing a viewer looking at a display device such as the AVDD 12 in FIG. 1;

FIG. 3 is a flow chart of example logic consistent with present principles;

FIG. 4 is a screen shot of an example user interface (UI) consistent with present principles;

FIG. 5 is a screen shot of an example UI for establishing user access setting profiles; and

FIG. 6 is a flow chart of example logic consistent with FIG. 5.

### DETAILED DESCRIPTION

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

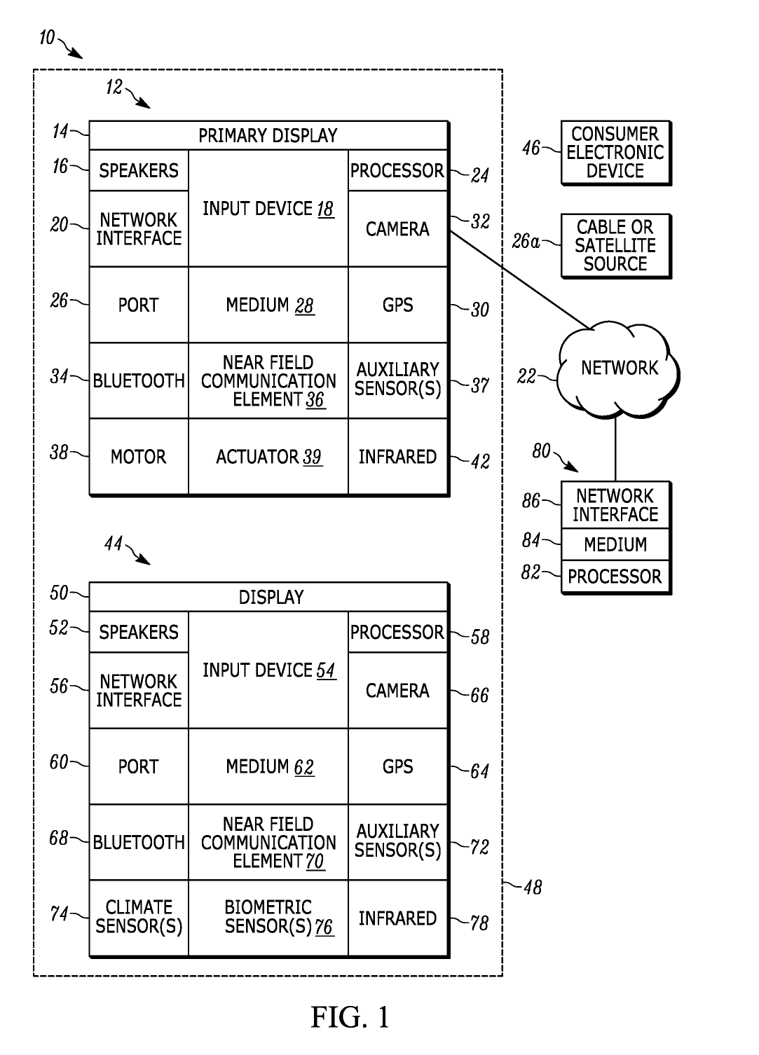

Now specifically referring to FIG. 1, an example ecosystem 10 is shown, which may include one or more of the example devices mentioned above and described further below in accordance with present principles. The first of the example devices included in the system 10 is an example primary display device, and in the embodiment shown is an audio video display device (AVDD) 12 such as but not limited to an Internet-enabled TV. Thus, the AVDD 12 alternatively may be an appliance or household item, e.g. computerized Internet enabled refrigerator, washer, or dryer. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or “8K” (or higher resolution) flat screen and that may be touch-enabled for receiving consumer input signals via touches on the display. The AVDD 12 may include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a USB port to physically connect (e.g. using a wired connection) to another CE device and/or a headphone port to connect headphones to the AVDD 12 for presentation of audio from the AVDD 12 to a consumer through the headphones. The AVDD 12 may further include one or more computer memories 28 that are not transitory signals, such as disk-based or solid state storage (including but not limited to flash memory). Also in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command, etc.) providing input to the processor 24. The AVDD 12 may include still other sensors such as e.g. one or more climate sensors 38 (e.g. barometers, humidity sensors, wind sensors, light sensors, temperature sensors, etc.) and/or one or more biometric sensors 40 providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still referring to FIG. 1, in addition to the AVDD 12, the system 10 may include one or more other CE device types. In one example, a first CE device 44 may be used to control the display via commands sent through the below-described server while a second CE device 46 may include similar components as the first CE device 44 and hence will not be discussed in detail. In the example shown, only two CE devices 44, 46 are shown, it being understood that fewer or greater devices may be used.

In the example shown, to illustrate present principles all three devices 12, 44, 46 are assumed to be members of an entertainment network in, e.g., in a home, or at least to be present in proximity to each other in a location such as a house. However, for illustrating present principles the first CE device 44 is assumed to be in the same room as the AVDD 12, bounded by walls illustrated by dashed lines 48.

The example non-limiting first CE device 44 may be established by any one of the above-mentioned devices, for example, a portable wireless laptop computer or notebook computer, and accordingly may have one or more of the components described below. The second CE device 46 without limitation may be established by a wireless telephone. The second CE device 46 may implement a portable hand-held remote control (RC).

The first CE device 44 may include one or more displays 50 that may be touch-enabled for receiving consumer input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface. It is to be understood that the processor 58 may control the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a USB port to physically connect (e.g. using a wired connection) to another CE device and/or a headphone port to connect headphones to the first CE device 44 for presentation of audio from the first CE device 44 to a consumer through the headphones. The first CE device 44 may further include one or more computer memories 62 such as disk-based or solid state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command, etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44. The second CE device 46 may include some or all of the components shown for the CE device 44.

Now in reference to the afore-mentioned at least one server 80, it includes at least one server processor 82, at least one computer memory 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server, and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby.

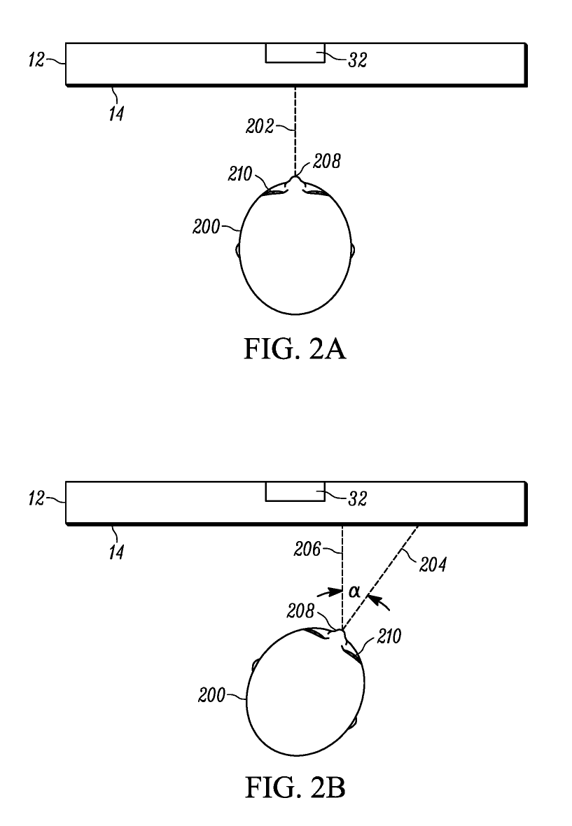

FIGS. 2A and 2B show that a viewer 200 may gaze straight at a display device such as the display 14 of the AVDD 12, as indicated by the viewing line 202, or the viewer may gaze along a viewing line 204 that is at an angle α that may be oblique to the perpendicular 206 between the display device and the viewer. In the latter case, particularly if the viewer 200 gazes along the oblique viewing line 204 for a prolonged time, it may be inferred that the viewer is visually impaired.

Note that while FIGS. 2A and 2B both show that the nose 208 and irises 210 are “pointed” in the same direction, meaning that the viewer has turned his head to move his gaze, it is to be understood that the viewer's head may be turned straight toward the display device as shown in FIG. 2A but the irises turned along the oblique viewing line 204 shown in FIG. 2B. In one example embodiment, the viewing line in such a case can be taken to be the oblique viewing line 204 in FIG. 2B along which the irises 210 gaze, not the perpendicular viewing line 202 in FIG. 2A toward which the nose 208 points. In another embodiment, in the case of the above “mismatch” between the direction the nose points and the direction the irises look, the viewing line may be taken to be the direction in which the nose points.

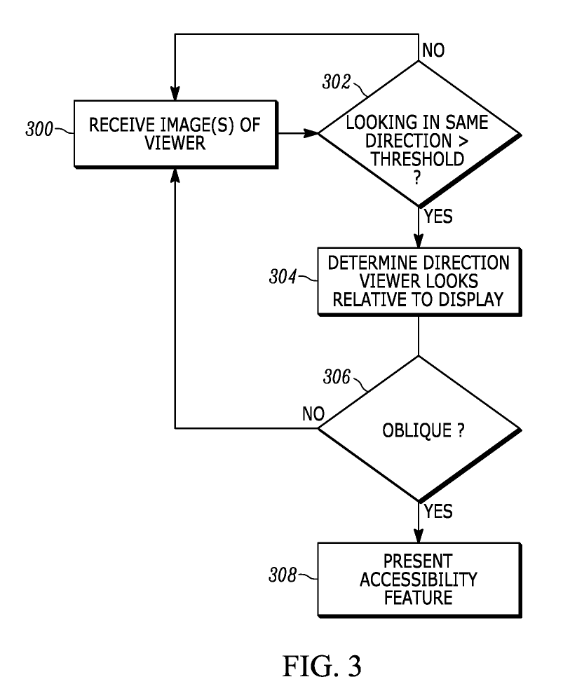

With the above in mind, reference is now made to FIG. 3. Commencing at block 300, one or more images are received of the viewer 200. The images may be generated by the camera 32 shown in FIGS. 1, 2A, and 2B, and the camera 32 may be conveniently mounted centrally on the AVDD 12 as shown so that images it produces of the viewer 200 are “normalized” to the perpendicular between the viewer and display device. If the camera 32 is offset from the center of the display, any parallax arising from such offset may be accounted for algorithmically.

In some examples, the logic may move to decision diamond 302 to determine if the viewer, based on the image(s), has been gazing in the same direction for at least a threshold period. While shown in flow chart format, it is to be understood that state logic may be employed. In any case, in examples using the threshold test at decision diamond 302, when the viewer is determined to have been gazing in the same direction for at least the threshold period, the logic moves to block 304 to determine the direction the viewer is looking relative to the AVDD 12, using image recognition. Equivalently, the user's eye focus may be determined. A single eye may be detected tracking motion on the screen, or both eyes may be detected tracking motion on the screen.

In one example, as indicated above the direction of viewer gaze is based on imaging the viewer's nose to determine the angle between the nose 208 and display (with zero angle indicating gazing directly along the perpendicular 202 in FIG. 2A). In other examples, images of the irises 210 are used to determine the angle. If it is determined at decision diamond 306 that the user is looking straight at the display (e.g., the display 14 of the AVDD 12, as shown in FIG. 2A), the logic may loop back to block 300. On the other hand, if it is determined at decision diamond 306 that the user is not looking straight at the display, i.e., that an oblique angle α exists relative the perpendicular 206 between the display device and the viewing line 204 (FIG. 2B), the logic may proceed to block 308 to automatically and without further user interaction present one or more accessibility features.

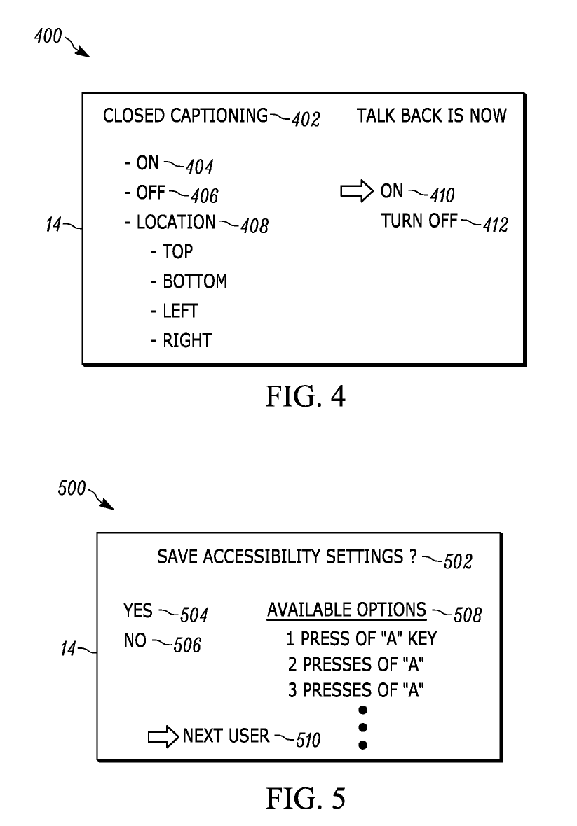

An example accessibility feature is an accessibility menu shown in FIG. 4.

As shown in FIG. 4, a UI 400 may include closed captioning options 402 selectable by means of moving a screen cursor using, e.g., a remote control. An on selector 404 may be selected to turn closed captioning on, meaning closed captioning will be presented on the AVDD 12, while an off selector 406 may be selected to turn off closed captioning.

When closed captioning is selected to be on, a list 408 of locations for the closed captioning may be provided to enable a user to select where the closed captioning will be presented on the display, e.g., at the top, or bottom, or left or right side of the display. The list 408 may be presented on the speakers of the AVDD 12 according to the talk back function.

Returning to the talk back function, as shown by the capitalized “on” message 410 talk back has been automatically enabled. An off selector 412 may be selected to turn off the talk back function.

While FIG. 4 illustrates a UI that can be presented as an accessibility feature at block 308 of FIG. 3, other accessibility features are contemplated. As an example, the talk back feature may be automatically invoked without presenting the UI 400, and/or closed captioning may be invoked or removed (if already invoked).

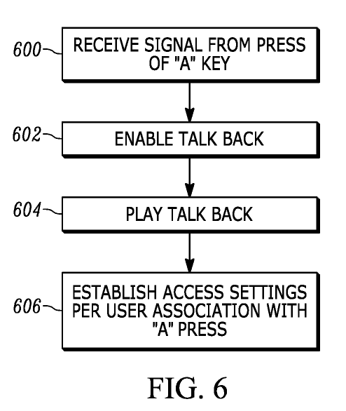

FIGS. 5 and 6 illustrate still further examples of alternative or additional accessibility features. FIG. 5 illustrates a UI 500 that may be invoked on the AVDD 12 at block 308 of FIG. 3 to prompt a user to save accessibility settings currently activated on the AVDD 12, and/or as may have been established using the UI 400 of FIG. 4. A user can select a yes selector 504 to save the settings and a no selector 506 to not save the settings.

Additionally, a list 508 may be presented of setting establishment enablement options. More particularly, by selecting a type of press of a remote control (RC) key (“A” key in FIG. 5) from the list 508, a user can correlate future presses of the selected type with the saved accessibility settings, which are automatically established in the AVDD 12 when future “A” key manipulations of the selected type are effected. For example, as shown the user can select to correlate his personal settings with one, two, or three (in quick succession) presses of the “A” key. Additional press type options may include a press and hold, two presses and holds, etc. A next user selector 510 may then be selected to enable another user to establish a different set of accessibility settings, including no special accessibility settings at all.

Thus, multiple users can correlate respective “A” key press types with respective accessibility settings. For instance, an impaired user may establish accessibility settings such as presenting closed captioning automatically simply by manipulating the “A” key according to the type of manipulation associated with the impaired user's settings. When the impaired user is absent, a non-impaired person may then establish his or her accessibility settings, including the removal of all special accessibility options if so set, automatically by manipulating the “A” key according to the non-impaired user's type of manipulation. In this way, accessibility settings can be easily and automatically changed by users according to their preference simply by manipulating a single top level key (the “A” key) on the RC.

While particular techniques are herein shown and described in detail, it is to be understood that the subject matter which is encompassed by the present application is limited only by the claims.

What is claimed is:

1. An article of manufacture comprising:
at least one computer memory that is not a transitory signal and that comprises instructions executable by at least one processor to:
receive at least one image of a person viewing a display device;
based at least in part on the image, determine a direction of viewing of the person and/or eye focus of the person; and
based at least in part on the direction of viewing and/or eye focus of the person, selectively present at least one accessibility feature on the display device.

2. The article of manufacture of claim 1, wherein the instructions are executable to:
at a first time, determine that the direction of viewing is directly at the display device;
responsive to determining that the direction of viewing is directly at the display device, not present the at least one accessibility feature on the display device;
at a second time, determine that the direction of viewing is not directly at the display device; and
responsive to determining that the direction of viewing is not directly at the display device, present the at least one accessibility feature on the display device.

3. The article of manufacture of claim 1, wherein the instructions are executable to:
determine the direction of viewing of the person only after the at least one image indicates that the person has looked in the direction of viewing for at least a predetermined period.

4. The article of manufacture of claim 1, wherein the accessibility feature comprises at least one user interface (UI).

5. The article of manufacture of claim 4, wherein the UI is audible.

6. The article of manufacture of claim 4, wherein the UI is visual.

7. The article of manufacture of claim 1, comprising the at least one processor.

8. The article of manufacture of claim 5, wherein the UI includes a talk back feature including an audio representation of accessibility options presented on a visual display.

9. A method, comprising:
receiving at least one image of a at least one viewer;
based at least in part on the at least one image, determining whether the at least one viewer is looking directly at an audio video display device (AVDD);
responsive to determining that the at least one viewer is looking directly at the AVDD, presenting or continuing to present video on the AVDD; and
responsive to determining that the at least one viewer is not looking directly at the AVDD, automatically presenting at least one accessibility feature related to the AVDD.

10. The method of claim 9, comprising receiving the at least one image from at least one camera on the AVDD.

11. The method of claim 9, comprising executing the determining only after elapse of a period during an entirety of which the viewer was looking in a constant direction.

12. The method of claim 9, wherein the accessibility feature comprises at least one user interface (UI).

13. The method of claim 12, wherein the UI is audible.

14. The method of claim 12, wherein the UI is visual.

15. The method of claim 13, wherein the UI includes a talk back feature including an audio representation of accessibility options presented on a visual display of the AVDD.

16. A system comprising:
at least one audio video device (AVD) comprising at least one video display and at least one audio speaker;
at least one camera on the AVD; and
circuitry configured for:
receiving from the at least one camera at least one image of at least one viewer; and
based at least in part on the at least one image indicating that the at least one viewer is not looking directly at the video display, automatically presenting on the AVDD at least one accessibility feature.

17. The system of claim 16, wherein the circuitry is configured to, responsive to the at least one image indicating that the at least one viewer is not looking directly at the video display, actuate a talk back function of the AVDD.

18. The system of claim 16, wherein the circuitry comprises at least one processor.

19. The system of claim 16, wherein the accessibility feature comprises at least one user interface (UI).

20. The system of claim 19, wherein the UI is audible and/or visual.
